(19) United States
(12) Patent Application Publication
(10) Pub. No.: US 2014/0371980 A1
(43) Pub. Date: Dec. 18, 2014

(54) WHEEL POSITION DETECTOR AND TIRE INFLATION PRESSURE DETECTOR HAVING THE SAME

(71) Applicant: DENSO CORPORATION, Kariya-city, Aichi-pref. (JP)

(72) Inventors: Takatoshi Sekizawa, Obu-city (JP); Masashi Mori, Obu-city (JP); Noriaki Okada, Chiryu-city (JP); Nobuya Watabe, Nagoya-city (JP)

(21) Appl. No.: 14/374,636

(22) PCT Filed: Feb. 5, 2013
(86) PCT No.: PCT/JP2013/000615

§ 371 Date: Jul. 25, 2014

(30) Foreign Application Priority Data
Feb. 7, 2012 (JP) 2012-024125

(51) Int. Cl. B60C 23/04

(52) U.S. Cl. CPC B60C 23/0416; B60C 23/0488; B60C 23/0489
USPC 701/34.4

(57) ABSTRACT

In a wheel position detector for a vehicle, a transmitter on each wheel repeatedly transmits a data frame containing identification information when an angle of the transmitter reaches a transmission angle. A receiver for receiving the frame is mounted on a body of a vehicle and performs wheel position detection, based on the frame, to specify a target wheel from which the frame is transmitted. The receiver acquires a tooth position of a gear rotating with a corresponding wheel when receiving the frame. The receiver specifies the target wheel based on a frequency with which the tooth position appears.

### CROSS REFERENCE TO RELATED APPLICATION

This application is based on Japanese Patent Application No. 2012-24125 filed on Feb. 7, 2012, the disclosure of which is incorporated herein by reference.

### FIELD

The present disclosure relates to a wheel position detector that automatically detects where a target tire wheel is mounted in a vehicle. The wheel position detector may be used for a direct-type tire inflation pressure detector that detects a tire inflation pressure by directly attaching a transmitter having a pressure sensor to a wheel mounted with a tire, transmitting a detection result from the pressure sensor via the transmitter, and receiving the detection result by a receiver mounted on the vehicle.

### BACKGROUND

A direct-type tire inflation pressure detector has been known. This type of tire inflation pressure detector uses a transmitter that is directly attached to a tire wheel of a vehicle. The transmitter has a sensor such as a pressure sensor. An antenna and a receiver are mounted on a body of the vehicle. When the transmitter transmits data including a detection signal from the sensor, the receiver receives the data via the antenna and detects a tire inflation pressure based on the data. The direct-type tire inflation pressure detector determines whether the data is transmitted from the vehicle equipped with the direct-type tire inflation pressure detector or another vehicle. Further, the direct-type tire inflation pressure detector determines which wheel is provided with the transmitter. For this purpose, each data transmitted from the transmitter contains ID information that discriminates between the vehicle and the other vehicle and identifies a wheel to which the transmitter is attached.

In order to locate the transmitter, the receiver needs to pre-register the ID information about each transmitter in association with each wheel position. If tire rotation is performed, the receiver needs to re-register the ID information. For example, patent document 1 proposes a method of automating this registration.

Specifically, in the method according to a patent document 1, it is determines whether the wheel reaches a specified rotation position based on an acceleration detection signal from an acceleration sensor included in the transmitter attached to the wheel. The vehicle also detects a rotation position of the wheel based on a wireless signal from the transmitter. The vehicle monitors a change in a relative angle between the rotation positions to specify the wheel position. This method monitors a change in the relative angle between the wheel rotation position detected by the vehicle and the wheel rotation position detected by the wheel based on a deviation in a specified number of data. The method specifies the wheel position by determining that a variation with reference to an initial value exceeds an allowable value. More specifically, the number of teeth of a gear (i.e., rotor) is obtained from a wheel speed pulse outputted from a wheel speed sensor provided for a corresponding wheel. The wheel position is specified based on a relative angle between a rotation angle indicated by the number of teeth of the gear obtained from the wheel speed pulse outputted from the wheel speed sensor and a rotation position detected based on the acceleration detection signal from the acceleration sensor included in the transmitter attached to the wheel.

However, the method described in patent document 1 specifies the wheel position based on whether a variation belongs to an allowable range defined by a specified allowable value with reference to an initial value. The method cannot specify the wheel position while the variation belongs to the allowable range. Further, a variation in the wheel speed pulse outputted from the wheel speed sensor becomes large in a low-speed region where the vehicle runs at a low speed. Therefore, in the low-speed region, the number of teeth of the gear obtained from the wheel speed pulse may be inaccurate, and the wheel position may be inaccurately specified.

### CITATION LIST

### Patent Literature

[PTL 1]
JP-A-2010-122023

### SUMMARY

It is an object of the present disclosure to provide a wheel position detector and a tire inflation pressure detector having a wheel position detector capable of accurately specifying a wheel position in a shorter period of time even in a low-speed region where a vehicle runs at a low speed.

According to a first aspect of the present disclosure, a wheel position detector is used for a vehicle including a body and wheels mounted on the body. Each wheel is equipped with a tire. The wheel position detector includes transmitters. Each transmitter is mounted on a corresponding wheel and has unique identification information. Each transmitter includes a first control section for generating and transmitting a data frame containing the unique identification information. The wheel position detector further includes a receiver mounted on the body of the vehicle. The receiver includes a second control section and a reception antenna. The second control section receives the frame via the reception antenna from one of the transmitters at a time. The second control section performs wheel position detection, based on the frame, to specify one of the wheels on which the one of the transmitters is mounted. The second control section stores a relationship between the one of the wheels and the unique identification information of the one of the transmitters. The wheel position detector further includes wheel speed sensors. Each wheel speed sensor is provided with a gear rotating with the corresponding wheel. The gear has teeth with electrical conductivity. The gear further has intermediate portions alternately arranged with the teeth along an outer periphery of the gear so that a magnetic resistance of the gear changes along the outer periphery. Each wheel speed sensor outputs a tooth detection signal indicative of a passage of each of the teeth. Each transmitter further includes an acceleration sensor configured to output an acceleration detection signal indicative of acceleration having a gravity acceleration component varying with a rotation of the corresponding wheel. The first control section detects an angle of the transmitter based on the gravity acceleration component of the acceleration detection signal from the acceleration sensor. The transmitter forms the angle with a central axis of the corresponding wheel and a predetermined reference zero point on a circumference of the corresponding wheel. The first control section repeatedly transmits the frame each time the angle of the transmitter reaches a transmission angle. The second control section acquires a tooth position of the gear based on the tooth detection signal from the wheel speed sensor when the receiver receives the frame. The tooth position indicates the number of edges or teeth of the gear. The second control section accumulates data of the acquired tooth position for each wheel and for each identification information. The second control section counts the number of edge numbers or tooth numbers above a predetermined threshold value. The second control section performs the wheel position detection based on the counted number and based on whether the counted number increases.

According to a second aspect of the present disclosure, a tire inflation pressure detector includes the wheel position detector according to the first aspect. Each transmitter further includes a sensing section for outputting a pressure detection signal indicative of a tire inflation pressure of the tire of the corresponding wheel. The first control section of each transmitter processes the pressure detection signal to acquire inflation pressure information about the tire inflation pressure and generates the frame in such a manner that the frame contains the pressure inflation information. The second control section of the receiver detects the tire inflation pressure of the tire of the corresponding wheel based on the inflation pressure information contained in the frame.

### BRIEF DESCRIPTION OF DRAWINGS

The above and other objects, features and advantages of the present disclosure will become more apparent from the following detailed description made with reference to the accompanying drawings. In the drawings:

FIG. 1 illustrates an overall configuration of a tire inflation pressure detector including a wheel position detector according to an embodiment;

FIG. 2A illustrates a block configuration of a transmitter and a receiver;

FIG. 2B illustrates a block configuration of a transmitter and a receiver;

FIG. 3 is a timing chart illustrating the wheel position detection;

FIG. 4 illustrates changes of gear information;

FIG. 5 illustrates frequency graphs;

FIG. 6 illustrates a change in a vehicle speed;

FIG. 7 illustrates a change in a frequency graph with over time; and

FIG. 8 illustrates a flow chart of a wheel position detection process.

### DESCRIPTION OF EMBODIMENTS

Embodiments of the present disclosure will be described below with reference to the drawings.

### Embodiment

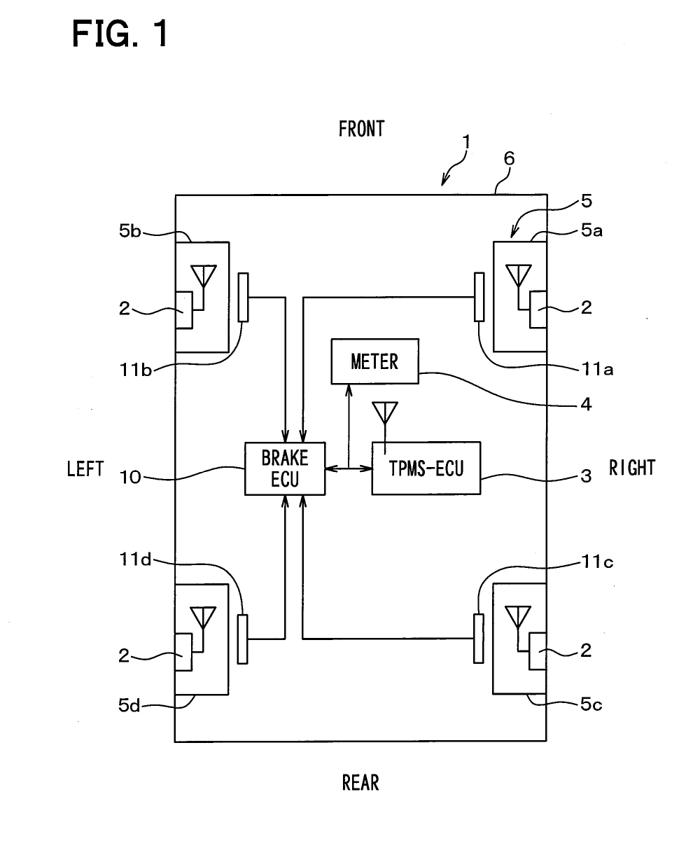

A tire inflation pressure detector including a wheel position detector according to an embodiment of the present disclosure is described below with reference to FIG. 1. FIG. 1 illustrates an overall configuration of the tire inflation pressure detector. The top of FIG. 1 indicates the front of a vehicle 1. The bottom of FIG. 1 indicates a rear of the vehicle 1.

As illustrated in FIG. 1, the tire inflation pressure detector is attached to the vehicle 1 and includes a transmitter 2, an electronic control unit (ECU) 3 for the tire inflation pressure detector, and a meter 4. The ECU 3 functions as a receiver and is hereinafter referred to as the TPMS-ECU (Tire Pressure Monitoring System ECU) 3. To specify a wheel position, the wheel position detector uses the transmitter 2 and the TPMS-ECU 3. In addition, the wheel position detector acquires gear information from a brake control ECU (hereinafter referred to as the brake ECU) 10. The gear information is generated from detection signals of wheel speed sensors 11a-11d. The wheel speed sensors 11a-11d are respectively provided for tire wheels 5 (5a-5d).

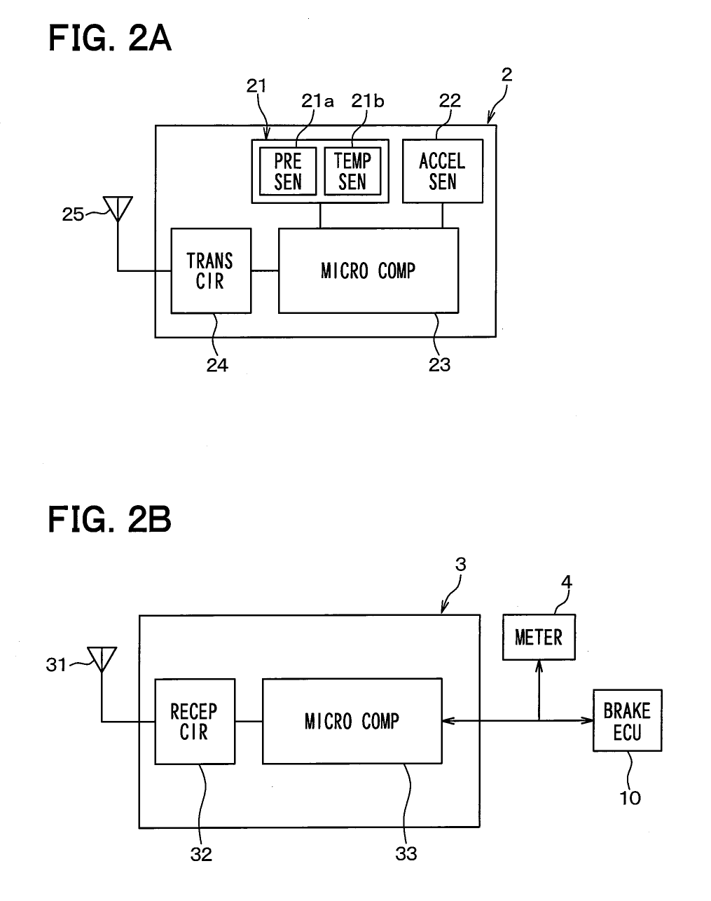

As illustrated in FIG. 1, the transmitter 2 is attached to each of the wheels 5a-5d. The transmitter 2 detects inflation pressures of tires mounted on the wheels 5a-5d. The transmitter 2 stores information about the tire inflation pressure as a detection result in a data frame and transmits the frame. The TPMS-ECU 3 is attached to a body 6 of the vehicle 1. The TPMS-ECU 3 receives the frame transmitted from the transmitter 2 and detects a wheel position and a tire inflation pressure by performing various processes and operations based on the detection result stored in the frame. The transmitter 2 modulates the frame according to frequency-shift keying (FSK), for example. The TPMS-ECU 3 demodulates the frame, reads the information stored in the frame, and detects the wheel position and the tire inflation pressure. FIG. 2A illustrates a block diagram of the transmitter 2, and FIG. 2B illustrates a block diagram of the TPMS-ECU 3.

As illustrated in FIG. 2A, the transmitter 2 includes a sensing section 21, an acceleration sensor 22, a microcomputer 23, a transmission circuit 24, and a transmission antenna 25. These components of the transmitter 2 are driven by power supplied from a battery (not shown).

For example, the sensing section 21 includes a diaphragm-type pressure sensor 21a and a temperature sensor 21b. The sensing section 21 outputs a detection signal indicative of the tire inflation pressure and/or a tire temperature. The acceleration sensor 22 detects a position of the sensor itself at the wheels 5a-5d where the transmitter 2 is attached. That is, the acceleration sensor 22 detects a position of the transmitter 2 and a speed of the vehicle 1. For example, according to the embodiment, the acceleration sensor 22 outputs a detection signal indicative of acceleration acting on the rotating wheels 5a-5d in the radial direction of the wheels 5a-5d, namely, in both directions perpendicular to the circumferential direction of the wheels 5a-5d.

The microcomputer 23 includes a control section (first control section) and is configured according to a known technology. The microcomputer 23 performs a predetermined process according to a program stored in an internal memory of the control section. The internal memory of the control section stores separate ID information that contains transmitter identification information to specify each transmitter 2 and vehicle identification information to specify the vehicle 1.

The microcomputer 23 receives a detection signal indicative of the tire inflation pressure from the sensing section 21, processes the signal, and modifies it as needed. Then, the microcomputer 23 stores information about the tire inflation pressure and the transmitter identification information in the frame. The microcomputer 23 monitors the detection signal from the acceleration sensor 22 to detect the speed of the vehicle 1 and to detect the position of each transmitter 2 attached to the wheels 5a-5d. When the microcomputer 23 generates the frame, the microcomputer 23 allows the transmission circuit 24 to transmit the frame to the TPMS-ECU 3 via the transmission antenna 25 based on the speed of the vehicle 1 and the position of the transmitter 2.

Specifically, the microcomputer 23 starts transmitting the frame on when the vehicle 1 is running. The microcomputer 23 repeatedly transmits the frame based on the detection signal from the acceleration sensor 22 each time an angle of the acceleration sensor 22 reaches a transmission angle. The microcomputer 23 determines whether the vehicle is running based on the speed of the vehicle 1. The microcomputer 23 determines whether the angle of the acceleration sensor 22 reaches the transmission angle based on the position of the transmitter 2.

The microcomputer 23 detects the speed of the vehicle 1 using the detection signal from the acceleration sensor 22. The microcomputer 23 determines that the vehicle is running when the speed of the vehicle 1 reaches a predetermined speed (e.g., 3 km/h) or larger. An output of the acceleration sensor 22 includes the centrifugal acceleration, namely, the acceleration based on a centrifugal force. The speed of the vehicle 1 can be calculated by integrating the centrifugal acceleration and multiplying the integral of the centrifugal acceleration by a predetermined coefficient. The microcomputer 23 calculates the centrifugal acceleration by excluding a gravity acceleration component from the output of the acceleration sensor 22 and calculates the speed of the vehicle 1 based on the centrifugal acceleration.

The acceleration sensor 22 outputs detection signals according to rotations of the wheels 5a-5d. While the vehicle 1 is running, the detection signal contains a gravity acceleration component and indicates the amplitude corresponding to the wheel rotation. For example, the detection signal indicates the maximum negative amplitude when the transmitter 2 is positioned just above a central axis of each of the wheels 5a-5d. The detection signal indicates zero amplitude when the transmitter 2 is positioned level with the central axis. The detection signal indicates the maximum positive amplitude when the transmitter 2 is positioned just below the central axis. The angle of the acceleration sensor 22, i.e., an angle of the position of the transmitter 2 can be determined based on the amplitude. For example, the angle of the acceleration sensor 22 can be determined based on the amplitude by assuming that the angle is 0 degree when the acceleration sensor 22 is positioned just above the central axis of each of the wheels 5a-5d.

Each transmitter 2 starts transmitting the frame (i.e., transmits the first frame) at the same time when the speed of the vehicle 1 reaches the predetermined speed or when the acceleration sensor 22 reaches the transmission angle after the speed of the vehicle 1 reaches the predetermined speed. The transmitter 2 repeatedly transmits the frame each time when the angle of the acceleration sensor 22 becomes the angle at which the transmitter 2 transmitted the first frame. Alternatively, the transmitter 2 can transmit the frame only once in a predetermined time period (e.g., 15 seconds) to reduce battery consumption.

The transmission circuit 24 functions as an output section for transmitting the frame, received from the microcomputer 23, to the TPMS-ECU 3 via the transmission antenna 25. For example, the frame is transmitted by using electromagnetic waves of radio frequency.

For example, the transmitter 2 is attached to an inflation valve on each of the wheels 5a-5d in such a manner that the sensing section 21 can be exposed to an inside of the tire, for example. The transmitter 2 detects the tire inflation pressure of a corresponding tire. As described above, when the speed of the vehicle 1 exceeds the predetermined speed, each transmitter 2 repeatedly transmits the frame via the transmission antenna 25 each time the acceleration sensor 22 reaches the transmission angle. The transmitter 2 may always transmit the frame each time the acceleration sensor 22 reaches the transmission. It is desirable to elongate the frame transmission interval to reduce battery consumption. To this end, the transmitter 2 can change from a wheel-positioning mode to a periodic transmission mode when the time required to determine the wheel position elapsed. In this case, in the wheel-positioning mode, the transmitter 2 transmits the frame each time the acceleration sensor 22 reaches transmission angle. In contrast, in the periodic transmission mode, the transmitter 2 transmits the frame at a longer interval (e.g., every one minute), thereby periodically transmitting a signal concerning the tire inflation pressure to the TPMS-ECU 3. For example, a random delay may be provided for each transmitter 2 so that each transmitter 2 can transmit the frame at a different timing. In such an approach, interference of radio waves from the transmitters 2 is prevented so that the TPMS-ECU 3 can surely receive the frames from the transmitters 2.

As illustrated in FIG. 2B, the TPMS-ECU 3 includes a reception antenna 31, a reception circuit 32, and a microcomputer 33. As described later, the TPMS-ECU 3 acquires gear information from the brake ECU 10 via an in-vehicle LAN such as a control area network (CAN), thereby acquiring a tooth position indicated by the number of edges of teeth (or the number of teeth) of a gear rotating with each of the wheels 5a-5d.

The reception antenna 31 receives the frames transmitted from the transmitters 2. The reception antenna 31 is fixed to the body 6 of the vehicle 1. The reception antenna 31 may be provided as an internal antenna incorporated in the TPMS-ECU 3 or provided as an external antenna having a wiring extending from an inside to an outside of the TPMS-ECU 3.

The reception circuit 32 functions as an input section for receiving the frames from the transmitters 2 via the reception antenna 31 and for sending the received frames to the microcomputer 33.

The microcomputer 33 corresponds to a second control section and performs wheel position detection in accordance with a program stored in an internal memory of the microcomputer 33. Specifically, the microcomputer 33 performs the wheel position detection based on a relationship between the gear information acquired from the brake ECU 10 and a reception timing at which the frame is received from the transmitter 2. The microcomputer 33 acquires the gear information from the brake ECU 10 at a predetermined acquisition interval (e.g., 10 ms). The gear information is generated from the wheel speed sensors 11a-11d, which are respectively provided for the wheels 5a-5d.

The gear information indicates the tooth position of the gear rotating with the wheels 5a-5d. For example, each of the wheel speed sensors 11a-11d is configured as an electromagnetic pick-up sensor and placed to face the teeth of the gear. A detection signal outputted from the wheel speed sensors 11a-11d changes each time the tooth of the gear passes the wheel speed sensors 11a-11d. Specifically, the wheel speed sensors 11a-11d output a square-wave pulse as the detection signal each time the tooth of the gear passes the wheel speed sensors 11a-11d. Therefore, rising and falling edges of the square-wave pulse represent that the edge of the tooth of the gear passes the wheel speed sensors 11a-11d. Accordingly, the brake ECU 10 counts the number of the edges of the teeth of the gear passed the wheel speed sensors 11a-11d based on the number of the rising and falling edges of the detection signal from the wheel speed sensors 11a-11d. The brake ECU 10 notifies the microcomputer 33 of the count number as the gear information at the acquisition interval. Thus, the microcomputer 33 can identify when and which tooth of the gear passes the wheel speed sensors 11a-11d based on the gear information.

The count number is reset each time the gear makes one rotation. For example, assuming that the gear has 48 teeth, the edges are numbered from 0 to 95 so that 96 edges can be counted in total. When the count number reaches 95, the brake ECU 10 counts the number of the edges after resetting the count number to 0.

The brake ECU 10 can notify the microcomputer 33 of the number of the teeth passed the wheel speed sensors 11a-11d as the gear information instead of the number of the edges of the teeth passed the wheel speed sensors 11a-11d. Alternatively, the brake ECU 10 can notify the microcomputer 33 of the number of the edges or the number of the teeth that passed the wheel speed sensors 11a-11d during the last acquisition interval, and the microcomputer 33 can add the notified number to the latest count number of the edges or the teeth. In such an approach, the microcomputer 33 can count the number of the edges or the teeth at the acquisition interval. Namely, the microcomputer 33 just needs to be able to finally acquire the number of the edges or the teeth as the gear information at the acquisition interval. The brake ECU 10 resets the count number of the edges or the teeth each time the brake ECU 10 is powered off. The brake ECU 10 restarts counting at the same time when the brake ECU 10 is powered on or when the speed of the vehicle 1 reaches the predetermined speed after the brake ECU 10 is powered on. Therefore, the same tooth is represented by the same number of the edges or the teeth while the brake ECU 10 is powered on.

The microcomputer 33 measures the reception timing when receiving the frame transmitted from each transmitter 2. The microcomputer 33 performs the wheel position detection based on the number of gear edges or teeth which is selected from the acquired number of the edges or the teeth of the gear based on the reception timing. Thus, the microcomputer 33 can perform the wheel position detection that specifies which transmitter 2 is attached to which of the wheels 5a-5d. The wheel position detection will be described in detail later.

Based on a result of the wheel position detection, the microcomputer 33 stores the transmitter identification information along with the position of the wheels 5a-5d to which the transmitter 2 identified by the transmitter identification information is attached. After that, the microcomputer 33 detects the tire inflation pressures of the wheels 5a-5d based on the transmitter identification information stored in the frame transmitted from each transmitter 2 and data about the tire inflation pressure. The microcomputer 33 outputs an electric signal indicative of the tire inflation pressure to the meter 4 via the in-vehicle LAN such as CAN. For example, the microcomputer 33 compares the tire inflation pressure with a predetermined threshold pressure to detect a decrease in the tire inflation pressure. When the microcomputer 33 detects the decrease in the tire inflation pressure, the microcomputer 33 outputs a pressure decrease signal indicative of the decrease in the tire inflation pressure to the meter 4. Thus, the meter 4 is notified of which of the four wheels 5a-5d decreases the tire inflation pressure.

The meter 4 functions as an alarm section. As illustrated in FIG. 1, the meter 4 is located at a position where a driver can view the meter 4. For example, the meter 4 is configured as a meter display included in an instrument panel of the vehicle 1. When receiving the pressure decrease signal from the microcomputer 33 of the TPMS-ECU 3, the meter 4 provides an indication representing which of the wheels 5a-5d is subjected to a decrease in the tire inflation pressure. The meter 4 thereby notifies the driver of a decrease in the tire inflation pressure on a specific wheel.

The following describes operations of the tire inflation pressure detector according to the embodiment. The description below is divided into the wheel position detection and tire inflation pressure detection performed by the tire inflation pressure detector.

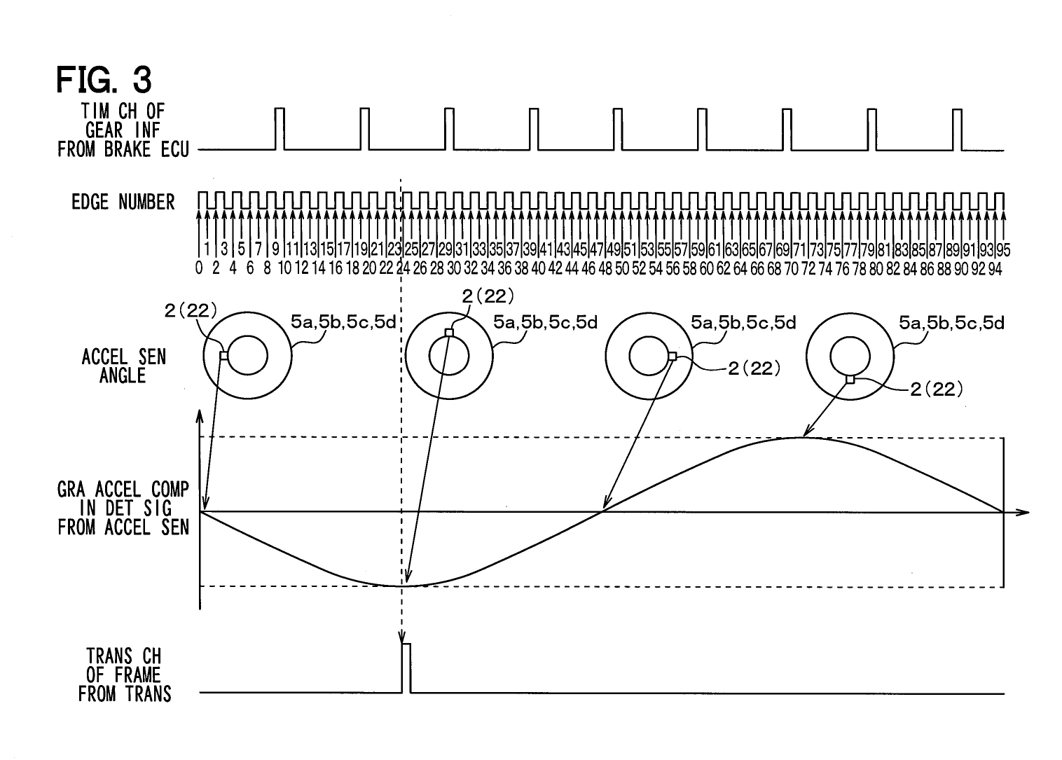

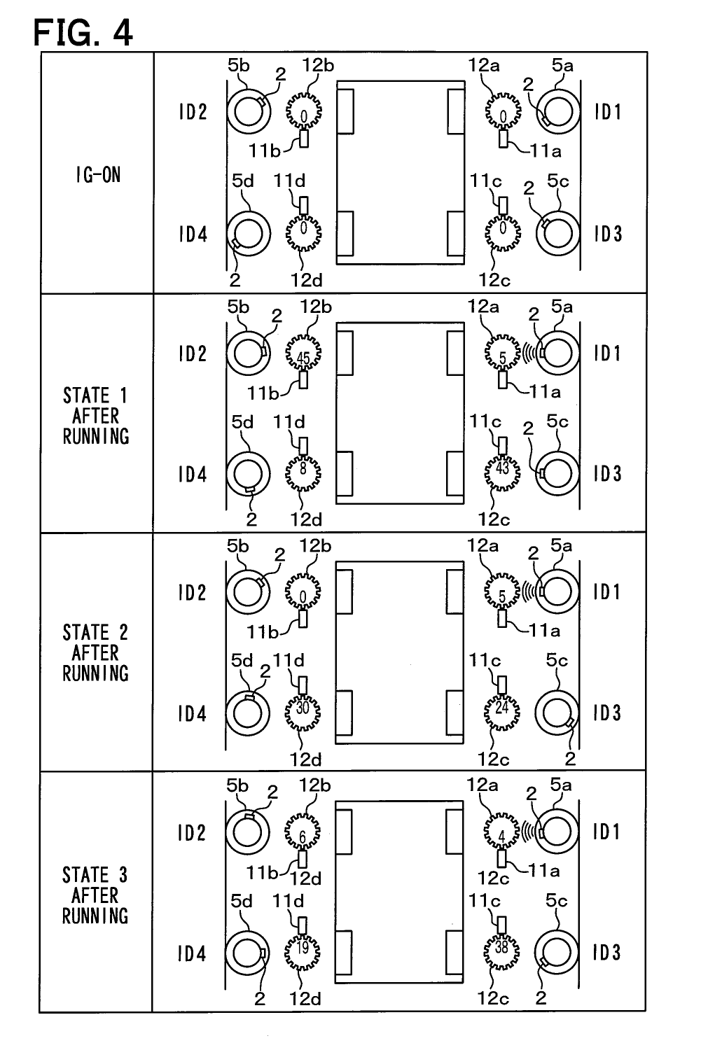

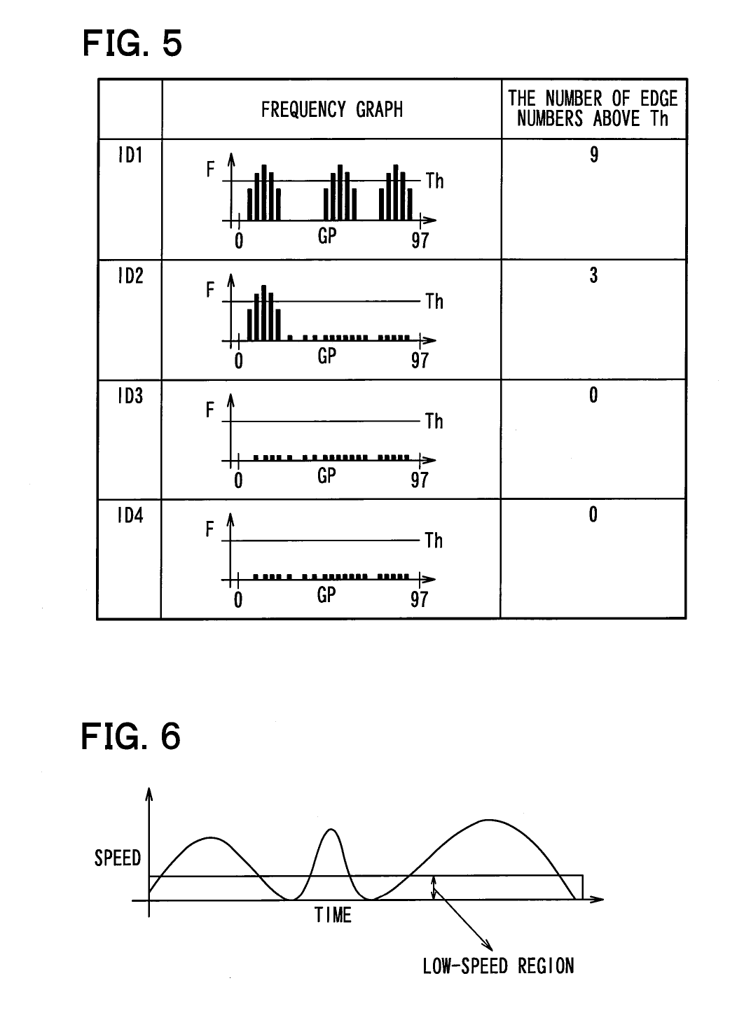

Firstly, the wheel position detection is described. FIG. 3 is a timing chart illustrating the wheel position detection. FIG. 4 illustrates changes in the gear information. FIGS. 5A, 5B, and 5C schematically illustrate a logic (i.e., principle) to detect the wheel position. FIGS. 6A, 6B, 6C, and 6D illustrate results of evaluating the wheel positions. With reference to these drawings, a method of performing the wheel position detection will be described.

On the transmitter 2, the microcomputer 23 monitors the detection signal from the acceleration sensor 22 at a predetermined sampling interval based on the power supplied from the battery. The microcomputer 23 thereby detects the speed of the vehicle 1 and the angle of the acceleration sensor 22 on each of the wheels 5a-5d. When the speed of the vehicle 1 reaches the predetermined speed, the microcomputer 23 repeatedly transmits the frame each time the acceleration sensor 22 reaches the transmission angle. For example, the transmission angle can be an angle of the acceleration sensor 22 immediately after the vehicle speed reaches the predetermined speed. Alternatively, the transmission angle can be a predetermined angle. Thus, the microcomputer 23 repeatedly transmits the frame each time the angle of the acceleration sensor 22 becomes equal to the angle at which the first frame was transmitted.

FIG. 3 shows, from the top to the bottom, a timing to acquire the gear information from the brake ECU 10, the number of gear edges, an angle of the acceleration sensor 22, a gravity acceleration component of the detection signal from the acceleration sensor 22, and a timing to transmit the frame from the transmitter 2. As illustrated in FIG. 3, the gravity acceleration component of the detection signal from the acceleration sensor 22 becomes a sine curve. The angle of the acceleration sensor 22 can be determined based on the sine curve. The frame is transmitted each time the acceleration sensor 22 reaches the same angle based on the sine curve.

The TPMS-ECU 3 acquires the gear information from the brake ECU 10 at the acquisition interval (e.g., 10 ms). The gear information is supplied from the wheel speed sensors 11a-11d respectively provided for the wheels 5a-5d. The TPMS-ECU 3 measures the reception timing when receiving the frame transmitted from each transmitter 2. The TPMS-ECU 3 acquires the number of gear edges or teeth which is selected from the acquired number of the edges or the teeth of the gear based on the reception timing.

The timing to receive the frame transmitted from each transmitter 2 does not always coincide with the interval to acquire the gear information from the brake ECU 10. For this reason, the number of gear edges or teeth indicated in the gear information acquired at the interval closest to the timing to receive the frame can be used as the number of gear edges or teeth at the timing to receive the frame. Namely, the number of gear edges or teeth indicated in the gear information acquired immediately before or after the interval to receive the frame can be used as the number of gear edges or teeth at the timing to receive the frame. The number of the edges or the teeth of the gear at the timing to receive the frame can be calculated by using the number of gear edges or teeth indicated in the gear information acquired immediately before and after the timing to receive the frame. For example, an average of the number of gear edges or teeth that is indicated in the gear information acquired immediately before and after the timing to receive the frame can be used as the number of gear edges or teeth at the timing to receive the frame.

The action to acquire the tooth position indicating the number of gear edges or teeth at the timing to receive the frame is repeated each time the frame is received. Data of the tooth position is stored, and the wheel position detection is performed based a frequency with the tooth position appears.

Assuming that the frame is received from a certain transmitter 2 on any one of the wheels 5a-5d, the certain transmitter 2 transmits the frame each time the acceleration sensor 22 of the certain transmitter 2 reaches the transmission angle. The tooth position almost matches the previous one since the tooth position is indicated by the number of gear edges or teeth at the timing to receive the frame. Consequently, a variation in the number of gear edges or teeth at the timing to receive the frame is small and falls within the variation allowable range. This also applies to a case of receiving the frame from the certain transmitter 2 more than once. That is, regarding the one of wheels 5a-5d on which the certain transmitter 2 is mounted, a variation in the number of gear edges or teeth at the timing to receive the frame falls within the variation allowable range that is set at the first frame reception timing at which the first frame is received from the certain transmitter 2. In contrast, regarding the others of the wheels 5a-5d, the tooth position varies since the frame is transmitted from the transmitter 2 on the others of wheels 5a-5d at timings different from the timing at which the frame is transmitted from the certain transmitter 2.

Specifically, the gears of the wheel speed sensors 11a-11d rotate in conjunction with the wheels 5a-5d, respectively. Therefore, the one of wheels 5a-5d, on which the certain transmitter 2 is mounted, hardly causes a variation in the number of gear edges or teeth at the timing to receive the frame. However, the wheels 5a-5d cannot rotate in exactly the same state because rotation states of the wheels 5a-5d vary due to, for example, a road condition, a turn, and a lane change. Therefore, the others of the wheels 5a-5d cause a variation in the tooth position that is indicated by the number of gear edges or teeth at the timing to receive the frame.

As illustrated in IG-ON of FIG. 4, gears 12a-12d of the respective wheel speed sensors 11a-11d indicate edge count 0 immediately after an ignition switch (IG) of the vehicle 1 is turned ON. After the vehicle 1 starts running, the frame is successively received from a given wheel. A wheel different from the given wheel causes a variation in the tooth position indicated by the number of gear edges or teeth. Therefore, a frequency with which the same tooth position appears at the timing to receive the frame is larger in the given wheel than in the different wheel. The tire inflation pressure detector performs the wheel position detection based on the frequency.

Specifically, since the gear information for each wheel can be acquired from the brake ECU 10, the number of gear edges or teeth acquired at the timing to receive each frame is stored for each wheel. FIG. 5 illustrates frequency graphs created by storing and collecting data of the tooth position (i.e., gear position GP) of the gear 11b, which rotates with the front left wheel 5b, acquired at the timing to receive the frames containing the respective transmitter identification information ID1-ID4. In the frequency graph, a horizontal axis represents the number of gear edges or teeth, and a vertical axis represents a frequency (F) with which the number of gear edges or teeth appears. FIG. 5 is based on the assumption that the gear 11b has 49 teeth, and the gear edges are numbered from 0 to 97. Such a frequency graph is created for each of the wheels 5a-5d.

As shown in FIG. 5, each time the frame is received, the number of gear edges or teeth acquired at the timing to receive the frame is stored and collected. The frequency with which the same number of gear edges or teeth appears varies depending on the number of gear edges or teeth.

That is, when the wheel specified by the brake ECU 10 is the same as the wheel on which the transmitter 2 that transmitted the frame is mounted, the timing at which the transmitter 2 transmitted the frame synchronizes with the tooth position acquired by the brake ECU 10. Therefore, a variation in the tooth position acquired at the timing to receive the frame is small so that almost the same tooth position can appear. For this reason, when the data of the tooth position is collected, it is likely that a specific tooth position appears with a higher frequency.

As shown in FIG. 6, if the speed of the vehicle 1 varies and decreases to a low-speed region during data collection, the tooth position may be detected inaccurately. However, when the speed of the vehicle 1 increases above the low-speed region, a specific tooth position appears with a higher frequency again. The specific tooth position appearing with a higher frequency after the speed of the vehicle 1 increases from the low-speed region above the low-speed region may be different from the specific tooth position appearing with a higher frequency before the speed of the vehicle 1 decreases to the low-speed region. However, as long as the wheel specified by the brake ECU 10 is the same as the wheel on which the transmitter 2 that transmitted the frame is mounted, a specific tooth position appears with a higher frequency after the speed of the vehicle 1 increases above the low-speed region. Thus, the tire inflation pressure detector can perform the wheel position detection based on the frequency even if the speed of the vehicle 1 decreases to the low-speed region.

In contrast, if the wheel specified by the brake ECU 10 is different from the wheel on which the transmitter 2 that transmitted the frame is mounted, the timing at which the transmitter 2 transmitted the frame does not synchronize with the tooth position acquired by the brake ECU 10. Therefore, a variation in the tooth position acquired at the timing to receive the frame is large so that various different tooth positions can appear. For this reason, even when the data of the tooth position is collected, it is less likely that a specific tooth position appears with a higher frequency.

It is noted that even if the wheel specified by the brake ECU 10 is different from the wheel on which the transmitter 2 that transmitted the frame is mounted, a specific tooth position may appear with a higher frequency immediately after the vehicle 1 starts to run. A reason for this is that the wheels that are located at the same position in a lateral direction of the vehicle 1 behave in a similar way. For example, in an example shown in FIG. 5, a specific tooth position appears with a higher frequency regarding the frames containing the respective transmitter identification information ID1 and ID2. However, the tooth position acquired at the timing to receive the frame containing the transmitter identification information ID2 varies with time. As a result, regarding the frame containing the transmitter identification information ID2, a state where a specific tooth position appears with a higher frequency does not continue for a long time.

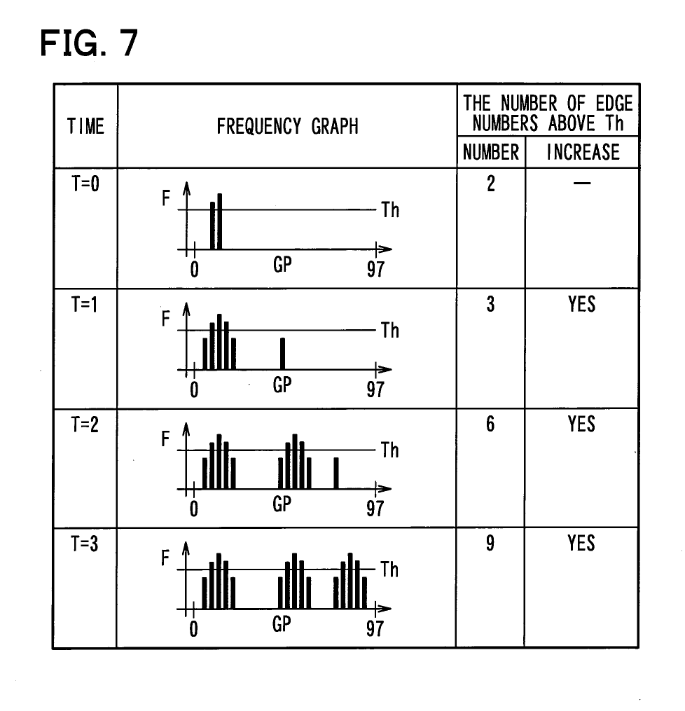

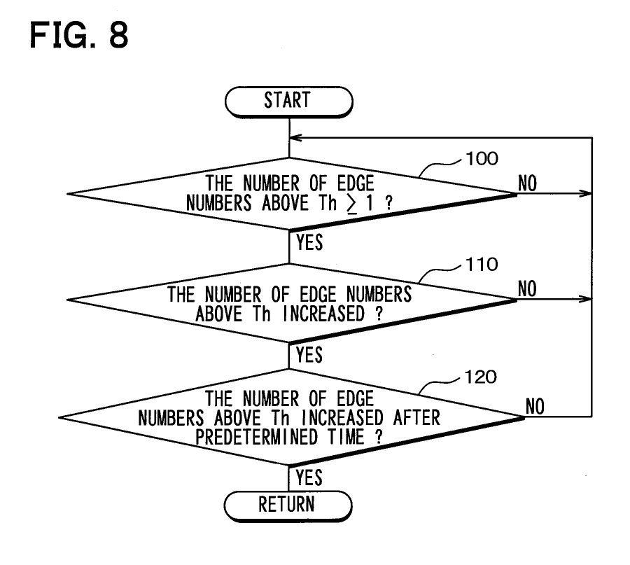

Based on the above analysis, according to the embodiment, the tooth position (i.e., gear edges or teeth) acquired at the timing to receive each frame is stored for each wheel, and the tire inflation pressure detector performs the wheel position detection based on the frequency with which the tooth position appears. FIG. 7 shows a change in a frequency graph with over time. The frequency graph shown in FIG. 7 is created by storing and collecting data of the tooth position of the gear 11b, which rotates with the front left wheel 5b, acquired at the timing to receive the frame containing the transmitter identification information ID1. Further, FIG. 7 shows a change in the number of tooth positions (i.e., gear positions) above a predetermined threshold value Th over time. Specifically, FIG. 7 shows a change in the number of gear edge numbers above the threshold value Th over time. FIG. 8 is a flow chart of a wheel position detection process to determine whether the transmitter 2 having the transmitter identification information ID1 is mounted on the front left wheel 5b. FIGS. 7 and 8 are based on the front left wheel 5b. The wheel position detection process is performed for the other wheels 5a, 5c, and 5d in the same manner as described below for the front left wheel 5b.

The data of the tooth position is accumulated each time the frame is received. The number of gear edge numbers or tooth numbers above the threshold value Th is counted at a predetermined time interval (T=0, 1, 2, 3, . . . ). In other words, the number of gear edge numbers or tooth numbers above the threshold value Th is counted whenever a predetermined time elapses. Further, it is determined whether the count number increased whenever the predetermined time elapses. Then, the determination result is stored in relation to the elapsed time. For example, as shown in FIG. 7, when the number of gear edge numbers or tooth numbers above the threshold value Th is 2 at the first counting time T=0, and the number of gear edge numbers or tooth numbers above the threshold value Th is 3 at the second counting time T=1, it is determined that the count number increased, and the determination result (i.e., YES: increase from 2 to 3) is stored in relation to the elapsed time (i.e., T=1). Likewise, when the number of gear edge numbers or tooth numbers above the threshold value Th is 6 at the third counting time T=2, it is determined that the count number increased, and the determination result (i.e., YES: increase from 3 to 6) is stored in relation to the elapsed time (i.e., T=2). Likewise, when the number of gear edge numbers or tooth numbers above the threshold value Th is 9 at the fourth counting time T=3, it is determined that the count number increased, and the determination result (i.e., YES: increase from 6 to 9) is stored in relation to the elapsed time (i.e., T=3). In this way, when the wheel specified by the brake ECU 10 is the same as the wheel on which the transmitter 2 that transmitted the frame is mounted, the number of gear edge numbers or tooth numbers above the threshold value Th exists and increases as the vehicle 1 runs.

In contrast, when the wheel specified by the brake ECU 10 is different from the wheel on which the transmitter 2 that transmitted the frame is mounted, the number of gear edge numbers or tooth numbers above the threshold value Th may exist but does not increase as the vehicle 1 runs.

Based on the above analysis, the data of the tooth position (i.e., gear edges or teeth) acquired at the timing to receive each frame is stored for each wheel 5a-5d and for each transmitter identification information ID1-ID4, and the tire inflation pressure detector performs the wheel position detection based on the accumulated data. For example, the wheel position detection process to determine whether the transmitter 2 having the transmitter identification information ID1 is mounted on the front left wheel 5b can be performed as shown in FIG. 8. The wheel position detection process is performed with a predetermined control cycle after the ignition switch of the vehicle 1 is turned ON from OFF.

As shown in FIG. 8, the wheel position detection process starts at step 100, where it is determined whether the number of gear edge numbers or tooth numbers above the threshold value Th exists. Specifically, at step 100, it is determined whether the number of gear edge numbers or tooth numbers above the threshold value Th is equal to or greater than 1. If the number of gear edge numbers or tooth numbers above the threshold value Th does not exist corresponding to NO at step 100, the wheel position detection process returns to step 100. A reason for this is that when the number of gear edge numbers or tooth numbers above the threshold value Th does not exist, it cannot be determined that the transmitter 2 that transmitted the frame containing the transmitter identification information ID1 is mounted on the front left wheel 5b. In contrast, if the number of gear edge numbers or tooth numbers above the threshold value Th exists corresponding to YES at step 100, the wheel position detection process proceeds to step 110.

At step 110, it is determined whether the number of gear edge numbers or tooth numbers above the threshold value Th increased. If the number of gear edge numbers or tooth numbers above the threshold value Th did not increase corresponding to NO at step 110, the wheel position detection process returns to step 100. A reason for this is that when the number of gear edge numbers or tooth numbers above the threshold value Th did not increase, it cannot be determined that the transmitter 2 that transmitted the frame containing the transmitter identification information ID1 is mounted on the front left wheel 5b. In contrast, if the number of gear edge numbers or tooth numbers above the threshold value Th increased corresponding to YES at step 110, the wheel position detection process proceeds to step 120.

At step 120, it is determined whether the number of gear edge numbers or tooth numbers above the threshold value Th increased again after a predetermined time elapsed. In this way, when the number of gear edge numbers or tooth numbers above the threshold value Th continuously increases, the wheel position detection process ends by determining that the transmitter 2 that transmitted the frame containing the transmitter identification information ID1 is mounted on the front left wheel 5b. Such a wheel position detection process is performed for each wheel 5a-5d and for each transmitter identification information ID1-ID4 to specify which transmitter 2 is mounted on which of the wheels 5a-5d.

In this way, the wheel on which the transmitter 2 that transmitted the frame is mounted is specified. Then, the microcomputer 33 registers the transmitter identification information of the transmitter 2 that transmitted the frame in relation to the position of the wheel on which the transmitter 2 is mounted. According to the embodiment, the registration is performed when step 120 is satisfied. Alternatively, the registration can be performed when step 100 or 110 is satisfied. However, as mentioned previously, even if the wheel specified by the brake ECU 10 is different from the wheel on which the transmitter 2 that transmitted the frame is mounted, a specific tooth position may appear with a higher frequency immediately after the vehicle 1 starts to run, because the wheels that are located at the same position in a lateral direction of the vehicle 1 behave in a similar way. Therefore, to accurately specify the wheel position, it is preferable that the registration should be performed when step 120 is satisfied.

After performing the wheel position detection, the tire inflation pressure detector performs the tire inflation pressure detection. Specifically, each transmitter 2 transmits the frame at a predetermined pressure detection interval during the tire inflation pressure detection. The TPMS-ECU 3 receives the frames for the four wheels 5a-5d each time the transmitter 2 transmits the frame. Based on the transmitter identification information contained in each frame, the TPMS-ECU 3 determines which of the transmitters 2 attached to the wheels 5a-5d transmitted the frame. The TPMS-ECU 3 detects the tire inflation pressures of the wheels 5a-5d based on the tire inflation pressure information contained in each frame. Thus, the TPMS-ECU 3 can detect a decrease in the tire inflation pressure of each of the wheels 5a-5d and determine which of the wheels 5a-5d is subjected to a decrease in the tire inflation pressure. The TPMS-ECU 3 notifies the meter 4 of the decrease in the tire inflation pressure. The meter 4 provides an indication representing the decrease in the tire inflation pressure while specifying any of the wheels 5a-5d. The meter 4 thereby notifies the driver of the decrease in the tire inflation pressure on a specific wheel.

As described above, according to the embodiment, the wheel position detector acquires the gear information indicating the tooth positions of the gears 12a-12d at a predetermined time interval based on detection signals from the wheel speed sensors 11a-11d that detect passage of teeth of the gears 12a-12d rotating with the wheels 5a-5d. Further, the data of the tooth position indicating the number of gear edges or teeth acquired at the timing to receive the frame is accumulated for each wheel and for each identification information. The number of edge numbers or tooth numbers above the threshold value Th is counted based on the accumulated data. The wheel position detection is performed based on the counted number and based on whether the counted number increases. In such an approach, the wheel position can be accurately specified. Further, even when the speed of the vehicle 1 decreases to the low-speed region, the wheel position detection can be continued. Thus, the wheel position detector according to the embodiment is capable of accurately specifying the wheel position in a shorter period of time even when the speed of the vehicle 1 decreases to the low-speed region.

The frame is transmitted when the vehicle speed reaches the predetermined speed. The position of the transmitter 2 on each of the wheels 5a-5d is detected by using the acceleration sensor 22. Thus, the wheel position detector can perform the wheel position detection immediately after the subject vehicle 1 starts to run, although the wheel position detection is available only after the subject vehicle 1 starts to run. Further, the wheel position detection can be performed without a trigger device unlike conventional wheel position detection that is performed based on the intensity of a received signal outputted from the trigger device.

### Other Embodiments

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

In the embodiment, an angle of the acceleration sensor 22 is 0 degree when the acceleration sensor 22 is positioned just above the central axis of each of the wheels 5a-5d. However, this is just an example. The angle of the acceleration sensor 22 can be 0 degree when the acceleration sensor 22 is located at any position on the circumference of each of the wheels 5a-5d.

In the embodiment, the TPMS-ECU 3 acquires the gear information from the brake ECU 10. Alternatively, another ECU may acquire the gear information, and the TPMS-ECU 3 may acquire the gear information from the other ECU. Alternatively, a detection signal from the wheel speed sensors 11a-11d may be inputted to the TPMS-ECU 3, and the TPMS-ECU 3 may acquire the gear information from the detection signal. According to the embodiment, the TPMS-ECU 3 and the brake ECU 10 are configured as separate ECUs but may be configured as an integrated ECU. In this case, the ECU is directly supplied with a detection signal from the wheel speed sensors 11a-11d and acquires the number of gear tooth edges or teeth from the detection signal. In this case, the number of gear tooth edges or teeth can be always acquired. The wheel position detection can be performed based on the gear information just at the frame reception timing unlike the case of acquiring the information at the specified cycle.

While the above-mentioned embodiment has described the wheel position detector provided for the subject vehicle 1 having the four wheels 5a-5d, the disclosure is also applicable to a vehicle having more wheels.

According to the disclosure, the wheel speed sensors 11a-11d just need to detect the passage of teeth of gears rotating with the wheels 5a-5d. Therefore, the gear just needs to be configured to provide different magnetic resistances by alternating a tooth having a conductive outer periphery and a portion between teeth. The gear is not limited to a general structure whose outer periphery is configured as an indented outer edge and forms a succession of conductive protrusions and non-conductive spaces. The gear includes a rotor switch whose outer periphery is configured as a conductive portion and a non-conductive insulator (see JP-A-H10-1998-048233), for example.

What is claimed is:

1. A wheel position detector for a vehicle, the vehicle including a body and a plurality of wheels mounted on the body, each wheel equipped with a tire, the wheel position detector comprising:
a plurality of transmitters, each transmitter mounted on a corresponding wheel and having unique identification information, each transmitter including a first control section for generating and transmitting a data frame containing the unique identification information;
a receiver mounted on the body of the vehicle and including a second control section and a reception antenna, the second control section configured to receive the frame via the reception antenna from one of the plurality of transmitters at a time, the second control section configured to perform wheel position detection, based on the frame, to specify one of the plurality of wheels on which the one of the plurality of transmitters is mounted, the second control section configured to store a relationship between the one of the plurality of wheels and the unique identification information of the one of the plurality of transmitters, and
a plurality of wheel speed sensors, each wheel speed sensor provided with a gear rotating with the corresponding wheel, the gear including a plurality of teeth having electrical conductivity and a plurality of intermediate portions alternately arranged with the plurality of teeth along an outer periphery of the gear so that a magnetic resistance of the gear changes along the outer periphery, each wheel speed sensor configured to output a tooth detection signal indicative of a passage of each of the plurality of teeth, wherein
each transmitter further includes an acceleration sensor configured to output an acceleration detection signal indicative of acceleration having a gravity acceleration component varying with a rotation of the corresponding wheel,
the first control section detects an angle of the transmitter based on the gravity acceleration component of the acceleration detection signal from the acceleration sensor,
the transmitter forms the angle with a central axis of the corresponding wheel and a predetermined reference zero point on a circumference of the corresponding wheel,
the first control section repeatedly transmits the frame each time the angle of the transmitter reaches a transmission angle,
the second control section acquires a tooth position of the gear based on the tooth detection signal from the wheel speed sensor when the receiver receives the frame,
the tooth position indicates the number of edges or teeth of the gear,
the second control section accumulates data of the acquired tooth position for each wheel and for each identification information,
the second control section counts the number of edge numbers or tooth numbers above a predetermined threshold value, and
the second control section performs the wheel position detection based on the counted number and based on whether the counted number increases,
the second control section registers a certain wheel as the one of plurality of wheels when a predetermined condition is satisfied again after an elapse of a predetermined time from when the condition is satisfied once, and
the condition is that the counted number associated with the certain wheel and the identification information of the one of the plurality of transmitters is more than one and increases.

2. (canceled)

3. (canceled)

4. A tire inflation pressure detector comprising:
the wheel position detector according to claim 1, wherein
each transmitter further includes a sensing section for outputting a pressure detection signal indicative of a tire inflation pressure of the tire of the corresponding wheel,
the first control section of each transmitter processes the pressure detection signal to acquire inflation pressure information about the tire inflation pressure and generates the frame in such a manner that the frame contains the pressure inflation information, and
the second control section of the receiver detects the tire inflation pressure of the tire of the corresponding wheel based on the inflation pressure information contained in the frame.
